(19) United States
(12) Patent Application Publication
(10) Pub. No.: US 2013/0040489 A1
(43) Pub. Date: Feb. 14, 2013

(54) Structure of Power Socket

(71) Applicant: Yi Hui Fang, Tao Yuang Hsien (TW)

(72) Inventor: Yi Hui Fang, Tao Yuang Hsien (TW)

(21) Appl. No.: 13/207,410

(22) Filed: Aug. 10, 2011

(51) Int. Cl. H01R 13/70

(52) U.S. Cl. 439/536

(57) ABSTRACT

An improved structure of power socket, which comprising: a casing block and a faceplate allowing to accommodate several power terminals, earthing terminals and electric switches, and the positive/negative contacts of power terminals, the contacts of earthing terminals and positive/negative contacts of electric switches are formed integrally at interval via a metal sheet, thus reducing substantially the number of spare parts and. facilitate the wiring; moreover, the faceplate is particularly made of transparent materials, allowing to visualize its interiors, improve the visual texture and sense of fashion, and also enhance the aesthetic feeling of indoor decorative environment; besides, the power socket can be applied to the faceplate of previous wall-mounted socket, enabling convenient replacement or assembly by the users, avoiding waste of resources and saving cost.

### BACKGROUND OF INVENTION

1. Field of the Invention

The present invention relates generally to a power socket, and more particularly to an improved one which allows to facilitate the assembly and reduce the cost by a simplified structure and transparent visual effect design of components.

2. Description of Related Art

As shown in FIG. 1, a wall-mounted common power socket 1 generally comprises: at least a socket 10 and an electric switch 11, of which the electric switch 11 could control the on/off state via the socket 10, thus improving the safety and preventing electric shock.

As shown in FIG. 2, said socket and electric switch are individually manufactured, and provided. with independent casings as well as electric parts and positive/negative terminals contained in the casings; hence, such devices must be manufactured. separately, resulting in higher material cost and time-consuming assembly; in particular, for the purpose of energization, at least a branch wire shall be linked professionally to the electric switch in addition to existing neutral wire, live wire and earthing wire; so the replacement and assembly is essentially a problem for the users, Besides, further improvement of the appearance is required given the fact that the appearance of the power socket is slightly modified all the time.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The primary objective of the present invention is to provide an improved structure of power socket, which could minimize the number of spare parts and combine the templates, so as to improve the assembly efficiency and reduce the cost with better applicability.

The second objective of the present invention is to provide an improved structure of power socket, which is fabricated by some transparent parts, so as to improve the visual texture and. sense of fashion, and also enhance the aesthetic feeling of indoor decorative environment.

The third objective of the present invention is to provide an improved structure of power socket, which can be applied to the faceplate of original wall-mounted socket, enabling convenient replacement or assembly by the users, avoiding waste of resources and saving cost.

For these purposes, the casing block and faceplate, etc, of the power socket are designed integrally to carry multiple power terminals and earthing terminals, enabling easier assembly and wiring for more convenient replacement of existing wall-mounted socket by the users. In the preferred embodiment, the power socket comprises: a T-shaped casing block, onto one surface of which two holding grooves are set correspondingly to its transverse direction, two caulking grooves are set correspondingly to its longitudinal direction and a trough is located between two caulking grooves; onto the other surface of which three wire holes are arranged correspondingly to two holding groove and the trough; a faceplate, mated with the casing block; onto one surface of which a holding space containing electric switch is set correspondingly to the transverse direction of T-shaped faceplate, and several slots are set correspondingly to the longitudinal direction; onto the other surface of which at least one socket is set in parallel; a power terminal, comprising of at least a positive contact arranged at interval into the caulking groove of the casing block, and at least a negative contact arranged at interval into the other caulking groove of the casing block; as well as an earthing terminal, comprising of at least a contact arranged at interval into the trough of the casing block. With this design, it is possible to realize the intended flexible operation, save more cost and avoid waste of resources.

The faceplate of said power socket can be fabricated by transparent materials, such that the power socket is aesthetically pleasing and fashionable, making it possible to enhance the aesthetic feeling of indoor decorative environment.

The other features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1: an external view of a conventional power socket.

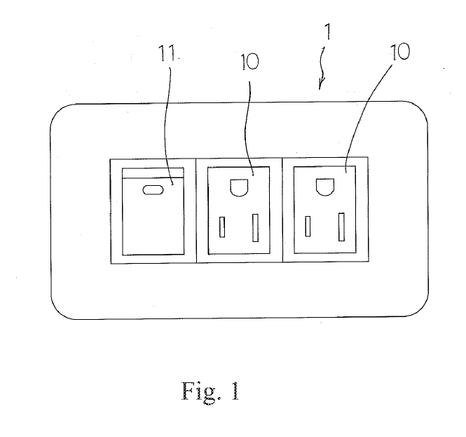

FIG. 2: a rear plain view of FIG. 1.

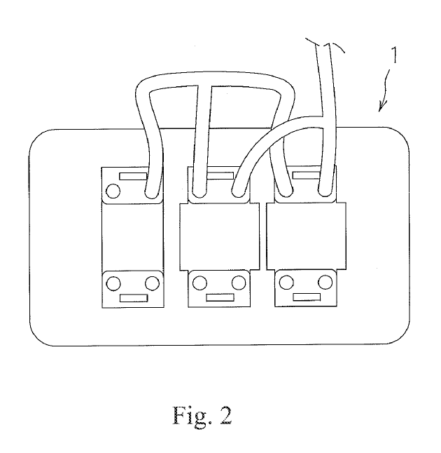

FIG. 3: an exploded view of a power socket of a preferred. embodiment of the present invention.

FIG. 4: an assembled view of a power socket of a preferred embodiment of the present invention.

FIG. 5: an exploded operating view of a power socket of a preferred. embodiment of the present invention.

FIG. 6: an assembled operating view of a power socket of a preferred embodiment of the present invention.

FIG. 7: an operating view of another preferred embodiment of the present invention.

### DETAILED DESCRIPTION OF THE INVENTION

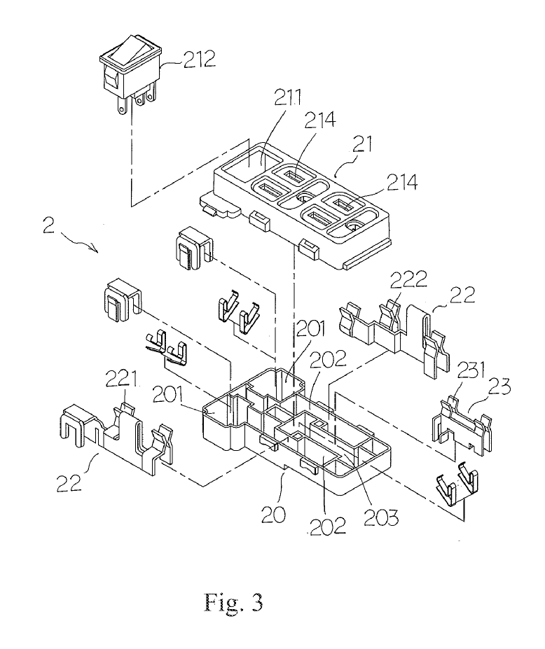

The improved power socket structure of a preferred embodiment of the present invention is illustrated in FIG. 3, wherein the power socket 2 comprising:

a T-shaped casing block 20, onto one surface of which two holding, grooves 201 are set correspondingly to its transverse direction, two caulking grooves 202 are set correspondingly to its longitudinal direction and a trough 203 is located, between two caulking grooves 202; onto the other surface of which three wire holes 204 are arranged correspondingly to two holding groove 201 and the trough 203;

a faceplate 21, mated with the casing block 20; onto one surface of which a holding space 211 containing electric switch 212 is set correspondingly to the transverse direction of T-shaped faceplate 21, and several slots 213 are set correspondingly to the longitudinal direction; onto the other surface of which at least one socket 214 is set in parallel; every socket includes neutral wire, live wire and earthing wire; moreover, the faceplate 21 is made of transparent materials, and the electric switch 212 is used for controlling the on/off of power supply in the socket 214;

a power terminal 22, comprising of at least a positive contact 221 arranged at interval into the caulking groove 202 of the casing block 20, and at least a negative contact 222 arranged at interval into the other caulking groove 202 of the casing block 20; and

an earthing terminal 23, comprising of at least a contact 231 arranged at interval into the trough 203 of the casing block 20.

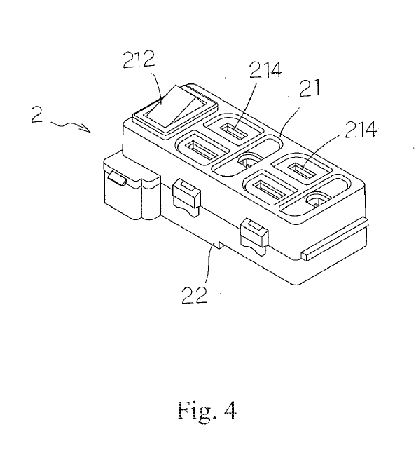

An external view of the power socket of a preferred embodiment of the present invention is illustrated. in FIG. 4, wherein the power terminal 22 and earthing terminal 23 are embedded one by one into the caulking groove 202 and trough 203 of the casing block 20, and the electric switch 212 is placed into the holding space 211 of the faceplate 21 for the assembly; as the faceplate 21 is made of transparent materials, the assembled power socket 1 allows users to visualize the power terminal 22 and earthing terminal 23 through the faceplate 21 with a fashionable and aesthetic feeling.

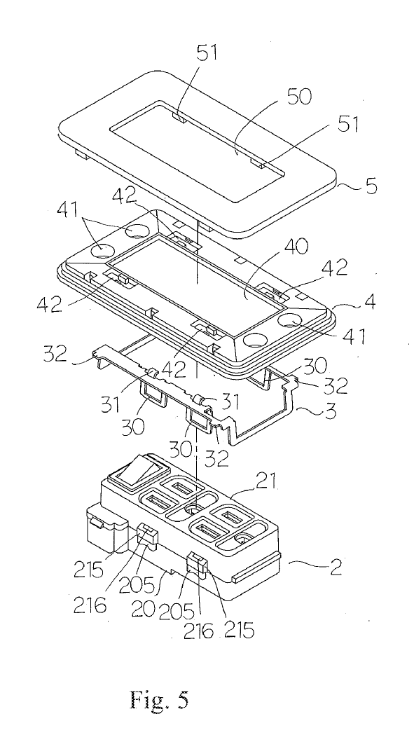

An exploded view of the power socket of a preferred embodiment of the present invention is illustrated. in FIG. 5, wherein the power socket 1 comprises: a metal frame 3, a baffle plate 4 and a ornamental plate 5; the metal frame 3 is completely sleeved onto the periphery of the power socket 1, and used to fix the casing block 20 and faceplate 21 against disengagement; in the actual operation, bulges 205, 215 are set correspondingly on the periphery of the casing block 20 and faceplate 21; moreover, a shallow slot 216 is set over the bulge 215 on the faceplate 21; meanwhile, some trapping portions 30 are formed on the metal frame 3 to locate tightly bulges 205, 215 correspondingly to the casing block 20 and faceplate 21, and an incurved hook 31 is set over every trapping portion 30 for snapping into the shallow slot 216, so the casing block 20 and faceplate 21 can be mated firmly; a perforated groove 40 allowing for penetration of the power socket 1 is set at the center of the baffle plate 4, and some fixed holes 41 are distributed on the opposite sides of the perforated groove 40, permitting to locate onto the wall by means of screwing with bolts or threading with steel nails; the baffle plate 4 can be combined with the power socket 1 by mating of the metal frame 3; a threading portion 32 is protruded separately close to the corner of the metal frame 3, allowing to penetrate and locate into a preset slot in the baffle plate 4; the ornamental plate 5 is a plate of smooth surface, which is provided. with a through-hole 50 mating with the periphery of the power socket 1, and a few tenons 51 set internally close to the corner that can be locked into the punch holes 42 set correspondingly onto the surface of the baffle plate 4; so the ornamental plate S and the baffle plate 4 can be combined.

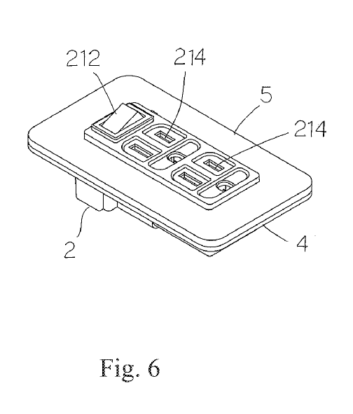

An assembled view of the power socket of a preferred embodiment of the present invention is illustrated in FIG. 6, wherein the metal frame 3 is sleeved firmly onto the periphery of the power socket 1, then mated with the baffle plate 4 and ornamental plate 5 to form a wall-mounted socket for civil applications.

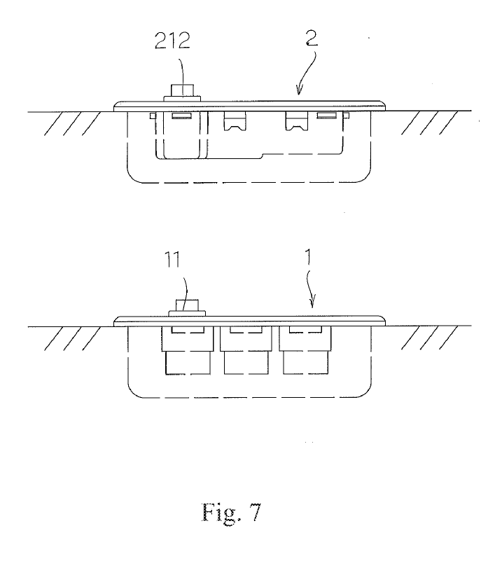

An operating view of the other preferred embodiment of the present invention is illustrated in FIG. 7, wherein the power socket 1 of the present invention can be mated with the self-designed metal frame 3, baffle plate 4 and ornamental plate 5, and also applied to previous wall-mounted socket; given the same size with existing socket, the power socket 1 of the present invention can be matched with the ornamental plate and baffle plate of previous wall-mounted socket, thus making it possible to realize the intended flexible operation, save more cost and avoid waste of resources.

To sum up, the power socket of the present invention is an innovative product not yet publicly available complying with the spirit of new patents, so the patent claims are made hereto.

Although the invention has been explained in relation to its preferred embodiment, it is to be understood that many other possible modifications and variations can be made without departing from the spirit and scope of the invention as hereinafter claimed.

1. An improved structure of power socket, which comprising:
a T-shaped casing block, onto one surface of which two holding grooves are set correspondingly to its transverse direction, two caulking grooves are set correspondingly to its longitudinal direction and a trough is located between two caulking grooves; onto the other surface of which three wire holes are arranged correspondingly to two holding groove and the trough;
a faceplate, mated with the casing block; onto one surface of which a holding space containing electric switch is set correspondingly to the transverse direction of T-shaped faceplate, and several slots are set correspondingly to the longitudinal direction; onto the other surface of which at least one socket is set in parallel;
a power terminal, comprising of at least a positive contact arranged at interval into the caulking groove of the casing block, and at least a negative contact arranged at interval into the other caulking groove of the casing block; and
an earthing terminal, comprising of at least a contact arranged at interval into the trough of the casing block.

2. The improved structure of power socket as claimed in claim 1, wherein said positive and negative power contacts are connected to the electric switch.

3. The improved structure of power socket as claimed in claim 1 or 2, wherein said faceplate is made of transparent materials.

4. improved structure of power socket as claimed in claim 1 or 2, wherein every said socket includes neutral wire, live wire and earthing wire.
